(19) United States
(12) Patent Application Publication
(10) Pub. No.: US 2015/0220013 A1
(43) Pub. Date: Aug. 6, 2015

(54) TONER

(71) Applicant: CANON KABUSHIKI KAISHA, Tokyo (JP)

(72) Inventors: Koji Nishikawa, Susono-shi (JP); Daisuke Yoshiba, Suntou-gun (JP); Yoshihiro Ogawa, Toride-shi (JP); Shigeto Tamura, Suntou-gun (JP); Naohiko Tsuchida, Abiko-shi (JP); Masami Fujimoto, Suntou-gun (JP)

(21) Appl. No.: 14/421,782

(22) PCT Filed: Sep. 18, 2013
(86) PCT No.: PCT/JP2013/075964

§ 371 Date: Feb. 13, 2015

(30) Foreign Application Priority Data
Sep. 20, 2012 (JP) 2012-206873

(51) Int. Cl. G03G 9/097; G03G 9/08

(52) U.S. Cl. CPC G03G 9/09775; G03G 9/0827

(57) ABSTRACT

Provided is a toner that shows both developability and electrostatic offset resistance. The toner includes a charge controlling agent that is represented by the following formula (1), and that has peaks at 15.000°±0.150° and 20.100°±0.150° in CuKα X-ray diffraction spectrum obtained in 2θ range of 10° or more to 40° or less where θ represents Bragg angle, one of the peaks being a peak having a maximum intensity and the other being a peak having a second maximum intensity.

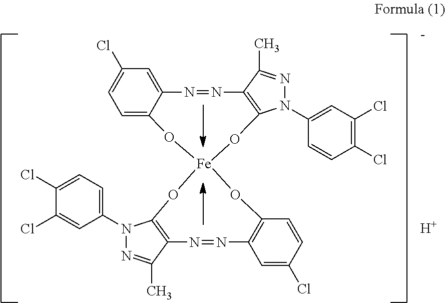

### TECHNICAL FIELD

The present invention relates to a negatively triboelectrically chargeable toner to be used in an image-forming method such as an electrophotographic method.

### BACKGROUND ART

In recent years, a copying machine or printer employing an electrophotographic method has started to be used in various nations and regions in association with market expansion. Meanwhile, the number of cases where such product is stored or used under a severe environment has been increasing, and hence an additionally high degree of maintenance of its quality has been required.

In a region where the temperature is high, such as Southeast Asia, India, or the Middle and Near East region, the temperature of an office is normally controlled to a normal temperature (e.g., 25° C.) with air conditioning equipment. However, when the air conditioning equipment is stopped, e.g., during a long vacation, the temperature may reach 45° C. In such case, the copying machine or printer may receive a day-and-night air temperature change, i.e., a heat cycle over a long time period. In addition, spare toner or the like may not be stored in an air-conditioned place. In such case, there is a possibility that the spare toner or the like receives the heat cycle at all times.

On the other hand, the environment under which a user actually uses the copying machine or printer in such region is often an air-conditioned low-temperature and low-humidity environment. In other words, the spare toner may be used under the low-temperature and low-humidity environment after having been stored for a long time period while receiving the heat cycle.

When toner is stored under a heat cycle environment for a long time period, the deterioration of the toner progresses and its charging performance is liable to reduce. On the other hand, the charging performance of the toner easily appears in a significant manner under a low-temperature and low-humidity environment. In other words, the toner whose charging performance has reduced is liable to cause various image defects under the low-temperature and low-humidity environment.

An example of the image defects in such case is an electrostatic offset. The electrostatic offset is an image defect that is liable to occur under the low-temperature and low-humidity environment owing to the insufficiently charged toner, and the toner offsets over the entire region of a document. Accordingly, it has been absolutely necessary to alleviate the offset.

The charging characteristics of toner need to be controlled in order that stable toner performance may be exerted irrespective of an environmental fluctuation like the case where the toner is used under a low-temperature and low-humidity environment after a heat cycle as described above. A charge controlling agent has heretofore been used in the toner as a method of controlling the charging characteristics of the toner.

For example, Patent Literatures 1 and 2 each disclose a pyrazolone monoazo iron complex compound as a charge controlling agent for toner. The literatures each describe that when the charge controlling agent is used in toner, the charge rising performance of the toner is high and a fluctuation in charge quantity thereof is small even under high temperature and high humidity (35° C. and 85% RH). However, when image output is performed with toner to which the pyrazolone monoazo metal complex compound described in Patent Literature 1 or 2 has been merely added under a low-temperature and low-humidity environment after the toner has been left to stand under a heat cycle environment for a long time period, it is difficult to suppress the occurrence of the electrostatic offset. Accordingly, a toner capable of solving the problem has been required.

### CITATION LIST

### Patent Literature

PTL 1: International Patent WO2005/095523

PTL 2: Japanese Patent Application Laid-Open No. 2005-292820

### SUMMARY OF INVENTION

### Technical Problem

In view of the foregoing, the present invention is directed to providing a toner using a pyrazolone monoazo metal complex compound as a charge controlling agent, the toner showing excellent developability and excellent electrostatic offset resistance even when image output is performed under a low-temperature and low-humidity environment after the toner has been left to stand under a heat cycle environment for a long time period.

### Solution to Problem

According to one aspect of the present invention, there is provided a toner including toner particles each containing a binding resin and a charge controlling agent, in which the charge controlling agent
(i) includes a compound represented by the following formula (1), and
(ii) has peaks at 15.000°±0.150° and 20.100°±0.150° in CuKα X-ray diffraction spectrum obtained in 2θ range of 10° or more to 40° or less where θ represents Bragg angle, one of the peaks being a peak having a maximum intensity in the 2θ range and the other being a peak having a second maximum intensity in the 2θ range.

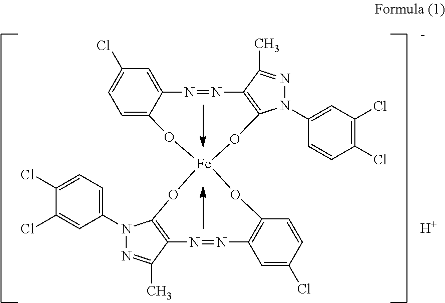

### Advantageous Effects of Invention

According to the present invention, there is provided the toner showing excellent developability and excellent electrostatic offset resistance even when image output is performed under a low-temperature and low-humidity environment after the toner has been left to stand under a heat cycle environment for a long time period.

Further features of the present invention will become apparent from the following description of exemplary embodiments with reference to the attached drawings.

### BRIEF DESCRIPTION OF DRAWINGS

FIG. 1 illustrates a surface modification apparatus to be used in Example 1 of the present invention.

FIG. 2 is the X-ray diffraction chart of a charge controlling agent (C-1) to be used in Examples 1 to 3 of the present invention.

FIG. 3 is the X-ray diffraction chart of a charge controlling agent (C-2) to be used in Example 4 of the present invention.

FIG. 4 is the X-ray diffraction chart of a charge controlling agent (C-3) to be used in Examples 5 to 8 of the present invention.

FIG. 5 is the X-ray diffraction chart of a charge controlling agent (C-4) to be used in Comparative Example 1 of the present invention.

FIG. 6 is the X-ray diffraction chart of a charge controlling agent (C-5) to be used in Comparative Example 2 of the present invention.

FIG. 7 is the X-ray diffraction chart of a charge controlling agent (C-6) to be used in Comparative Example 3 of the present invention.

FIG. 8 is the N₂ molecule adsorption-desorption isotherm of the charge controlling agent (C-1) to be used in Examples 1 to 3 of the present invention at 77 K.

FIG. 9 is the N₂ molecule adsorption-desorption isotherm of the charge controlling agent (C-5) to be used in Comparative Example 2 of the present invention at 77 K.

### DESCRIPTION OF EMBODIMENTS

A toner is constituted of a binding resin and any other additive. A charge controlling agent is generally added for imparting desired charging characteristics (such as a charging speed, a charging level, and charging stability), temporal stability, environmental stability, and the like. The addition of the charge controlling agent greatly improves the characteristics of the toner. The inventors of the present invention have made extensive studies concerning the charge controlling agent.

Then, the inventors have found that the use of a pyrazolone monoazo metal complex compound out of various charge controlling agents provides a negatively chargeable toner having a high charge quantity and having significantly high charge rising performance. Although a detailed reason why the pyrazolone monoazo metal complex has a high charge quantity and high charge rising performance has not been elucidated, the presence of a pyrazolone skeleton in a ligand may improve chargeability.

However, it has been difficult to suppress a reduction in developability and the occurrence of an electrostatic offset in image output under a low-temperature and low-humidity environment after the toner has been left to stand under an environment where a temperature change is repeated, i.e., a heat cycle environment for a long time period merely by using a charge controlling agent represented by the formula (1).

The electrostatic offset is a phenomenon that occurs when the toner on paper that has been insufficiently melted flies to a fixing film side near a fixing nip not thermally but electrostatically at the time of fixation. As a result, when the fixing film rotates once, the toner that has flown to the fixing film side is fixed to the paper again to cause an image defect.

In order that the electrostatic offset may be prevented, the surface of the fixing film is generally charged to the same polarity as the charged polarity of the toner to suppress the flying of the toner in many cases. However, when the charge distribution of the toner is broad, there is a high possibility that its charge quantity is small or an insufficiently charged toner charged to the opposite polarity is incorporated. In the case where the insufficiently charged toner is laid on paper, even when the surface of the fixing film is charged to the same polarity as that of the toner, an effect of the charging becomes small and hence the toner flies onto the fixing film near the fixing nip. As a result, the electrostatic offset occurs.

Therefore, the electrostatic offset is a problem that cannot be solved merely by improving the heat melting characteristics of the toner such as the so-called low-temperature fixability and hot offset resistance, and hence the control of the chargeability of the toner is important. In other words, it becomes more difficult for the electrostatic offset to occur as the uniformity of the chargeability of the toner at the time of the fixation improves.

In the present invention, conditions for a heat cycle were set as described below and then an evaluation was performed.

<1> A temperature is held at 25° C. for 1 hour.

<2> The temperature is linearly increased to 45° C. over 11 hours.

<3> The temperature is held at 45° C. for 1 hour.

<4> The temperature is linearly decreased to 25° C. over 11 hours.

A procedure from the items <1> to <4> was defined as 1 cycle and a total of 20 cycles were performed. The cycle from the items <1> to <4> is a reproduction of the image of a day's temperature change and 20 cycles were performed while a long vacation was assumed.

To suppress the reduction in developability and the occurrence of the electrostatic offset, the inventors of the present invention have made studies while paying attention to the crystal structure of the charge controlling agent represented by the formula (1). Then, as a result of their extensive studies, the inventors have found that when the charge controlling agent has a structure represented by the formula (1) and is of a crystal structure having a peak at a specific position in an X-ray diffraction spectrum, a toner excellent in developability and electrostatic offset resistance is obtained.

That is, the charge controlling agent of the present invention is that: the charge controlling agent has peaks at 15.000°±0.150° and 20.100°±0.150° in CuKα X-ray diffraction spectrum obtained in the 20 range of 10° or more to 40° or less where 0 represents Bragg angle, and one of the peaks is a peak having the maximum intensity in the 2θ range and the other is a peak having the second maximum intensity in the 2θ range; and the charge controlling agent is a compound represented by the following formula (1).

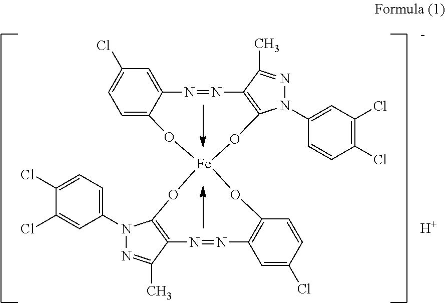

A toner is generally constituted of multiple raw materials. When the toner is left to stand under a heat cycle environment for a long time period, the raw materials typified by a charge controlling agent dispersed in the toner are liable to coalesce with each other or exude to the surface of the toner. As a result, raw material compositions in, and on the surface of, the toner become nonuniform, and hence the toner is liable to cause a charging failure. As a result, the charge distribution of the toner is liable to become broad and the electrostatic offset is liable to occur under a low-temperature and low-humidity environment.

The charge controlling agent is a material that affects the charging performance of the toner. The inventors of the present invention have considered that as long as the coalescence of the charge controlling agent in the toner and its exudation to the surface of the toner can be suppressed, the charging performance of the toner can be maintained even when the toner is left to stand under the heat cycle environment for a long time period. In view of the foregoing, the inventors of the present invention have paid attention to the crystal structure of the charge controlling agent, and have investigated its relevance with developability or electrostatic offset resistance.

As a result, the inventors have found that when the charge controlling agent has a structure represented by the formula (1), and has peaks at 15.000°±0.150° and 20.100°±0.150° in CuKα X-ray diffraction spectrum obtained in the 20 range of 10° or more to 40° or less where θ represents Bragg angle, and one of the peaks is a peak having the maximum intensity in the 2θ range and the other is a peak having the second maximum intensity in the 2θ range, the developability and the electrostatic offset resistance improve.

The charge controlling agent preferably has a peak having the third highest intensity at 15.950°±0.150° and a peak having the fourth highest intensity at 21.900°±0.150° in the CuKα X-ray diffraction spectrum obtained in the 2θ range of 10° or more to 40° or less because the developability and the electrostatic offset resistance additionally improve.

Although details about the reason for the foregoing have not been understood, the inventors of the present invention have assumed the reason to be as described below. When the charge controlling agent has such specific crystal structure, its affinities for a binding resin and any other additive improve. As a result, even when the toner is left to stand under the heat cycle environment for a long time period, the coalescence of the charge controlling agent dispersed in the toner and its exudation to the surface of the toner hardly occur, and hence its dispersion state in the toner can be held. The inventors of the present invention have suggested that as a result of the foregoing, the chargeability of the toner is kept uniform and hence the developability is maintained, and in addition, an insufficiently charged toner hardly adheres to a fixing film at the time of fixation, which can suppress the electrostatic offset.

It is because of the following reasons that the measurement range of the 2θ in the X-ray diffraction spectrum was set to 10° or more and 40° or less. First, the reason why the 2θ is 10° or more is that a low angle side, in other words, a side where the 2θ is small in the X-ray diffraction spectrum is slightly poor in reproducibility. This may be because the low angle side is a side where the spacing of the crystal plane of a substance to be subjected to measurement is wide, and hence various substances in air are liable to enter the crystal plane and the spacing is liable to change. Accordingly, a 2θ of 10° or more at which the same result was stably obtained even when reproducibility measurement was performed with the same sample was selected. Reproducibility was confirmed in the charge controlling agent of the present invention as well and a stable result is obtained in a region of 10° or more. Next, the reason why the 2θ is 40° or less is as described below. The charge controlling agent of the present invention showed no large diffraction peak at 40° or more. Accordingly, it was judged that measurement at up to 40° sufficed.

In the present invention, the charge controlling agent formed of the pyrazolone monoazo metal complex compound represented by the formula (1) can be produced by employing a known method of producing a monoazo complex compound. A representative production method is described below. First, a mineral acid such as hydrochloric acid or sulfuric acid is added to a diazo component such as 4-chloro-2-aminophenol. When the temperature of the resultant liquid becomes 5° C. or less, sodium nitrite dissolved in water is dropped while its liquid temperature is maintained at 10° C. or less. 4-Chloro-2-aminophenol is diazotized by stirring the mixture at 10° C. or less for 30 minutes to 3 hours or less to subject the mixture to a reaction. Sulfamic acid is added to the resultant and then it is confirmed with potassium iodide-starch paper that nitrous acid does not excessively remain.

Next, a coupling component that is 3-methyl-1-(3,4-dichlorophenyl)-5-pyrazolone, an aqueous solution of sodium hydroxide, sodium carbonate, and an organic solvent are added, and are then stirred and dissolved at room temperature. The diazo compound is poured into the solution and then coupling is performed by stirring the mixture at room temperature for several hours. After the stirring, it is confirmed that a reaction between the diazo compound and resorcin is absent, and this time point is defined as a reaction endpoint. After water has been added to the resultant, the mixture is sufficiently stirred and then left at rest, followed by liquid separation. An aqueous solution of sodium hydroxide is further added to the resultant, and then the mixture is stirred and washed, followed by liquid separation. Thus, a solution of a monoazo compound is obtained.

A monohydric alcohol, a dihydric alcohol, or a ketone-based organic solvent is preferred as the organic solvent to be used in the coupling. Examples of the monohydric alcohol include methanol, ethanol, n-propanol, 2-propanol, n-butanol, isobutyl alcohol, sec-butyl alcohol, n-amyl alcohol, isoamyl alcohol, and ethylene glycol monoalkyl (1 to 4 carbon atoms) ether. Examples of the dihydric alcohol include ethylene glycol and propylene glycol. Examples of the ketone-based solvent include methyl ethyl ketone and methyl isobutyl ketone.

Next, a reaction between the monoazo compound and a metal is performed. Water, salicylic acid, n-butanol, and sodium carbonate are added to the solution of the monoazo compound, and then the mixture is stirred. When iron is used as a coordination metal, an aqueous solution of ferric chloride and sodium carbonate are added.

The temperature of the resultant liquid is increased to 30° C. to 40° C. and then the reaction is monitored by thin-layer chromatography (TLC). After a lapse of 5 hours to 10 hours, it is confirmed that the spot of a raw material disappeared, and this time point is defined as a reaction endpoint. After the stirring has been stopped, the resultant is left at rest, followed by liquid separation. Water, n-butanol, and an aqueous solution of sodium hydroxide are further added to the resultant to perform alkali washing. The washed product is filtered, and then a cake is taken out and washed with water.

Further, a charge controlling agent having peaks at 15.000°±0.150° and 20.100°±0.150° in the X-ray diffraction spectrum, one of the peaks being a peak having the maximum intensity and the other being a peak having the second maximum intensity can be produced by, for example, a method as described below.

The cake washed with water in the forgoing is dissolved in an organic solvent. In this case, it is important to use, for example, the following organic solvent: dimethyl sulfoxide; N,N-dimethylformamide; a monohydric alcohol such as methanol, ethanol, n-propanol, 2-propanol, n-butanol, isobutyl alcohol, sec-butyl alcohol, n-amyl alcohol, isoamyl alcohol, or ethylene glycol monoalkyl (1 to 4 carbon atoms) ether; or a divalent alcohol such as ethylene glycol or propylene glycol.

The temperature of the solution is increased to 50° C. and then water is added while the solution is stirred. Thus, a charge controlling agent is gradually precipitated. At this time, an antifoaming agent is preferably added to the water to be added for suppressing the occurrence of bubbles in a system. Through such production, compounds having a uniform crystal structure can be obtained and a charge controlling agent having a desired X-ray diffraction spectrum is easily obtained. After having been cooled, the precipitated compound is filtered and then a cake is washed with water. Further, the cake is vacuum-dried, whereby the charge controlling agent of the present invention can be obtained.

When the charge controlling agent is internally added to toner particles, its addition amount is preferably 0.1 part by mass or more and 10 parts by mass or less, more preferably 0.2 part by mass or more and 5 parts by mass or less with respect to 100 parts by mass of a resin for toner. In addition, when the charge controlling agent is externally added to the toner particles, its addition amount is preferably 0.01 part by mass or more and 5 parts by mass or less, more preferably 0.01 part by mass or more and 2 parts by mass or less.

In terms of the electrostatic offset resistance, the charge controlling agent of the present invention is preferably such that in N₂ molecule adsorption-desorption isotherm at a temperature of 77 K, an adsorption amount M1 of an adsorption process when a relative pressure p/p₀ (p:adsorbtion equilibrium pressure, p₀: saturated vapor pressure) is 0.4 is 3.0 cm³/g or more and 8.0 cm³/g or less, and a difference (M2−M1) between the M1 and an adsorption amount M2 of a desorption process when the relative pressure p/p₀ is 0.4 is 0.4 cm³/g or less.

The N₂ molecule adsorption-desorption isotherm at a temperature of 77 K is constituted of an adsorption isotherm obtained by plotting an adsorption amount when the relative pressure of N₂ molecule is increased and a desorption isotherm obtained by plotting an adsorption amount when the relative pressure is reduced in contrast to the foregoing. The adsorption-desorption isotherm may adopt the so-called hysteresis structure in which the N₂ molecule adsorption amount of the desorption process is larger than the N₂ molecule adsorption amount of the adsorption process.

In the hysteresis, when the particles have an agglomerated state, N₂ molecule enters the heart of the agglomerated particle to adsorb in the adsorption process. Accordingly, even when the relative pressure reduces in the desorption process, the N₂ molecule cannot be completely desorbed and hence the hysteresis does not close. The phenomenon is called low-pressure hysteresis. The same phenomenon as the foregoing may occur in moisture at a molecular level as well.

In the case where the difference (M2−M1) between the adsorption amount M1 (cm³/g) of the adsorption process when the relative pressure p/p₀ is 0.4 and the adsorption amount M2 of the desorption process when the relative pressure p/p₀ is 0.4 is larger than 0.4, moisture is liable to enter the heart of the agglomerated particle to be accumulated at a molecular level owing to a change in saturated water vapor content due to a temperature change when a heat cycle is repeated. As a result, the charge distribution of the toner is liable to become broad and the electrostatic offset is liable to occur under a low-temperature and low-humidity environment.

In addition, the adsorption amount M1 (cm³/g) of the adsorption process is preferably 3.0 or more and 8.0 or less in order that the pyrazolone monoazo metal complex compound may obtain uniform dispersibility in toner.

In terms of the electrostatic offset resistance, a toner of the present invention is preferably such that the average circularity of the toner determined by dividing circularities, which are measured with a flow-type particle image-measuring apparatus having an image processing resolution of 512×512 pixels (0.37 μm×0.37 μm per pixel), into 800 sections in the circularity range of 0.200 or more to 1.000 or less and analyzing the circularities is 0.940 or more.

When the average circularity is 0.940 or more, preferably 0.950 or more, the shape of the toner becomes close to a spherical shape and hence a variation in charge quantity due to the shape reduces. In other words, the charge distribution of the toner becomes sharp. Accordingly, even when image output is performed under a low-temperature and low-humidity environment after the toner has been left to stand under a heat cycle environment for a long time period, the suppression of the electrostatic offset improves. Further, when the charge distribution of the toner is broad, the suppression of fogging that is liable to occur under the low-temperature and low-humidity environment also improves.

The measurement principle of a flow-type particle image analyzer “FPIA-3000” (manufactured by Sysmex Corporation) is as follows: a flowing particle is photographed as a still image and then image analysis is performed. A sample loaded into a sample chamber is fed into a flat sheath flow cell with a sample suction syringe. The sample fed into the flat sheath flow cell is sandwiched between sheath liquids to form a flat flow. The sample passing the inside of the flat sheath flow cell is irradiated with stroboscopic light at an interval of 1/60 second, and hence the flowing particle can be photographed as a still image. In addition, the particle is photographed in focus by virtue of the flat flow. The particle image is photographed with a CCD camera, the photographed image is subjected to image processing at an image processing resolution of 512×512 (0.19 μm×0.19 μm per pixel), the contour of each particle image is sampled, and a projected area S, perimeter L, and the like of the particle image are measured.

Next, a circle-equivalent diameter and circularity are determined by using the area S and the perimeter L. The term “circle-equivalent diameter” refers to the diameter of a circle having the same area as that of the projected area of the particle image, and the circularity C is defined as a value obtained by dividing the circumference of the circle determined from the circle-equivalent diameter by the perimeter of the particle projected image and is calculated from the following equation.

Circularity C=2×(π×S)^{1/2}/L

When a particle image is of a circular shape, the circularity becomes 1. A value for the circularity becomes smaller as the degree of the unevenness of the outer periphery of the particle image increases. After the circularity of each particle has been calculated, the arithmetic average of the resultant circularities is calculated and the value is defined as the average circularity.

The toner of the present invention is a toner having toner particles each containing a binding resin and a charge controlling agent.

The binding resin to be used in the present invention is described.

Examples of the binding resin include a polyester-based resin, a vinyl-based resin, an epoxy resin, and a polyurethane resin. In particular, from the viewpoint of uniform dispersion of a charge controlling agent having a polarity, incorporation of a polyester resin having a high polarity is generally preferred from the stand points of developability and electrostatic offset resistance.

The composition of the polyester resin is as described below.

A linear aliphatic diol is preferably contained as a dihydric alcohol component. Examples thereof include ethylene glycol, diethylene glycol, triethylene glycol, 1,2-propylene glycol, 1,3-propylene glycol, dipropylene glycol, 1,4-butanediol, 1,4-butadiene glycol, trimethylene glycol, tetramethylene glycol, pentamethylene glycol, hexamethylene glycol, octamethylene glycol, nonamethylene glycol, decamethylene glycol, and neopentyl glycol. When the linear aliphatic diol is contained, in some case, the polyester molecules have crystalline portions in which molecules are arranged. In this case, the resin can satisfactorily be mixed with a charge controlling agent having a crystal structure. Accordingly, it is possible to suppress the coalescence of the charge controlling agent in the toner and its exudation to the surface of the toner, and hence it becomes easy to obtain the effect of the present invention. It is preferred that the linear aliphatic diol be contained in an amount of 50% or more of the total alcohol components.

A bisphenol represented by the following formula (2) and a derivative thereof and a diol represented by the following formula (3) are given as aromatic diols.

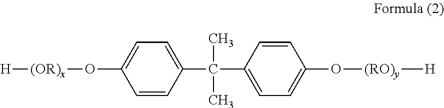

In the formula, R represents an ethylene or propylene group, x and y each represent an integer of 1 or more, and the average of x+y is 2 to 10.

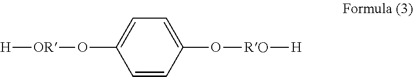

In the formula, R′ represents

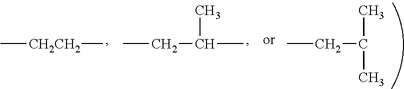

Examples of a divalent acid component include dicarboxylic acids and derivatives thereof such as: benzene dicarboxylic acids such as phthalic acid, terephthalic acid, isophthalic acid, and phthalic anhydride, or anhydrides or lower alkyl esters thereof; alkyldicarboxylic acids such as succinic acid, adipic acid, sebacic acid, and azelaic acid, or anhydrides or lower alkyl esters thereof; alkenylsuccinic acids or alkylsuccinic acids such as n-dodecenylsuccinic acid and n-dodecylsuccinic acid, or anhydrides or lower alkyl esters thereof; and unsaturated dicarboxylic acids such as fumaric acid, maleic acid, citraconic acid, and itaconic acid, or anhydrides or lower alkyl esters thereof.

In the present invention, a polyester obtained by subjecting a carboxylic acid component containing 90 mol % or more of an aromatic carboxylic acid compound and an alcohol component to condensation polymerization, 80 mol % or more of the aromatic carboxylic acid compound being terephthalic acid and/or isophthalic acid is preferred from the viewpoint of enhancement of dispersibility of the charge controlling agent although the reason therefor is unclear.

In addition, it is preferred that a trihydric or more alcohol component that functions as a crosslinking component or a trivalent or more acid component be used alone, or a combination thereof be used in order to attain more uniform dispersion of an internal additive such as magnetic iron oxide or wax.

Examples of a polyhydric alcohol component that is trihydric or more include: sorbitol; 1,2,3,6-hexanetetrol; 1,4-sorbitan; pentaerythritol; dipentaerythritol; tripentaerythritol; 1,2,4-butanetriol; 1,2,5-pentanetriol; glycerol; 2-methyl propanetriol; 2-methyl-1,2,4-butanetriol; trimethylolethane; trimethylolpropane; and 1,3,5-trihydroxybenzene.

Examples of a polyvalent carboxylic acid component that is trivalent or more include trimellitic acid, pyromellitic acid, 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, tetra(methylenecarboxyl)methane, 1,2,7,8-octanetetracarboxylic acid, and an empol trimer acid, and anhydrides thereof.

The alcohol component is contained at 40 mol % or more and 60 mol % or less, preferably 45 mol % or more and 55 mol % or less, and the acid component is contained at 40 mol % or more and 60 mol % or less, preferably 45 mol % or more and 55 mol % or less.

The polyester resin is typically obtained by generally known condensation polymerization.

On the other hand, the following monomers are given as a vinyl-based monomer for producing the vinyl-based resin.

For example, there are given: styrene; derivatives of styrene, such as o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, and p-n-dodecylstyrene; unsaturated monoolefins such as ethylene, propylene, butylene, and isobutylene; unsaturated polyenes such as butadiene and isoprene; vinyl halides such as vinyl chloride, vinylidene chloride, vinyl bromide, and vinyl fluoride; vinyl esters such as vinyl acetate, vinyl propionate, and vinyl benzoate; α-methylene aliphatic monocarboxylates such as methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; acrylates such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, and phenyl acrylate; vinyl ethers such as vinyl methyl ether, vinyl ethyl ether, and vinyl isobutyl ether; vinyl ketones such as vinyl methyl ketone, vinyl hexyl ketone, and methyl isopropenyl ketone; N-vinyl compounds such as N-vinylpyrrole, N-vinylcarbazole, N-vinylindole, and N-vinylpyrrolidone; vinylnaphthalenes; and acrylic acid or methacrylic acid derivatives such as acrylonitrile, methacrylonitrile, and acrylamide.

Further examples of the vinyl-based monomer include: unsaturated dibasic acids such as maleic acid, citraconic acid, itaconic acid, alkenylsuccinic acid, fumaric acid, and mesaconic acid; unsaturated dibasic acid anhydrides such as maleic anhydride, citraconic anhydride, itaconic anhydride, and alkenylsuccinic anhydride; unsaturated dibasic acid half esters such as methyl maleate half ester, ethyl maleate half ester, butyl maleate half ester, methyl citraconate half ester, ethyl citraconate half ester, butyl citraconate half ester, methyl itaconate half ester, methyl alkenylsuccinate half ester, methyl fumarate half ester, and methyl mesaconate half ester; unsaturated dibasic acid esters such as dimethyl maleate and dimethyl fumarate; α,β-unsaturated acids such as acrylic acid, methacrylic acid, crotonic acid, and cinnamic acid; α,β-unsaturated acid anhydrides such as crotonic anhydride and cinnamic anhydride, and anhydrides of the α,β-unsaturated acids and lower fatty acids; and monomers each having a carboxyl group such as alkenylmalonic acid, alkenylglutaric acid, and alkenyladipic acid, and acid anhydrides thereof and monoesters thereof.

Further examples of the vinyl-based monomer include: acrylic acid esters and mathacrylic acid esters such as 2-hydroxyethyl acrylate, 2-hydroxyethyl methacrylate, and 2-hydroxypropyl methacrylate; and monomers each having a hydroxy group such as 4-(1-hydroxy-1-methylbutyl)styrene and 4-(1-hydroxy-1-methylhexyl)styrene.

In the toner of the present invention, the vinyl-based resin of the binding resin may have a crosslinked structure crosslinked with a crosslinking agent having two or more vinyl groups.

Examples of the crosslinking agent to be used in this case include: aromatic divinyl compounds such as divinylbenzene and divinylnaphthalene; diacrylate compounds bonded by alkyl chains such as ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, and those obtained by changing the acrylate of the above-mentioned compounds to methacrylate; diacrylate compounds bonded by alkyl chains each containing an ether bond such as diethylene glycol diacrylate, triethylene glycol diacrylate, tetraethylene glycol diacrylate, polyethylene glycol #400 diacrylate, polyethylene glycol #600 diacrylate, dipropylene glycol diacrylate, and those obtained by changing the acrylate of the above-mentioned compounds to methacrylate; diacrylate compounds bonded by chains each containing an aromatic group and an ether bond such as polyoxyethylene(2)-2,2-bis(4-hydroxyphenyl)propane diacrylate, polyoxyethylene(4)-2,2-bis(4-hydroxyphenyl)propane diacrylate, and those obtained by changing the acrylate of the above-mentioned compounds to methacrylate; and polyester-type diacrylate compounds such as a product available under the trade name MANDA (Nippon Kayaku Co., Ltd.).

In addition, examples of the polyfunctional crosslinking agent include: pentaerythritol triacrylate, trimethylolethane triacrylate, trimethylolpropane triacrylate, tetramethylolmethane tetraacrylate, oligoester acrylate, and those obtained by changing the acrylate of the above-mentioned compounds to methacrylate; triallyl cyanurate; and triallyl trimellitate.

Any of those crosslinking agents can be used in an amount of preferably 0.01 part by mass or more and 10 parts by mass or less, more preferably 0.03 part by mass or more and 5 parts by mass or less with respect to 100 parts by mass of the other monomer components.

Of those crosslinking agents, an aromatic divinyl compound (particularly divinylbenzene) and diacrylate compounds bonded by chains each containing an aromatic group and an ether bond are given as ones to be suitably used.

As a polymerization initiator to be used when a vinyl-based copolymer is produced, there are given, for example, 2,2′-azobisisobutyronitrile, 2,2′-azobis(4-methoxy-2,4-dimethylvaleronitrile), 2,2′-azobis(-2,4-dimethylvaleronitrile), 2,2′-azobis(-2-methylbutyronitrile), dimethyl-2,2′-azobisisobutyrate, 1,1′-azobis(1-cyclohexanecarbonitrile), 2-(carbamoylazo)-isobutyronitrile, 2,2′-azobis(2,4,4-trimethylpentane), 2-phenylazo-2,4-dimethyl-4-methoxyvaleronitrile, 2,2′-azobis(2-methylpropane), ketone peroxides such as methyl ethyl ketone peroxide, acetylacetone peroxide, and cyclohexanone peroxide, 2,2-bis(t-butylperoxy)butane, t-butyl hydroperoxide, cumene hydroperoxide, 1,1,3,3-tetramethylbutyl hydroperoxide, di-t-butyl peroxide, t-butylcumyl peroxide, dicumyl peroxide, α,α′-bis(t-butylperoxyisopropyl)benzene, isobutyl peroxide, octanoyl peroxide, decanoyl peroxide, lauroyl peroxide, 3,5,5-trimethylhexanoyl peroxide, benzoyl peroxide, m-trioyl peroxide, diisopropyl peroxydicarbonate, di-2-ethylhexyl peroxydicarbonate, di-n-propyl peroxydicarbonate, di-2-ethoxyethyl peroxycarbonate, dimethoxyisopropyl peroxydicarbonate, di(3-methyl-3-methoxybutyl) peroxycarbonate, acetylcyclohexylsulfonyl peroxide, t-butyl peroxyacetate, t-butyl peroxyisobutyrate, t-butyl peroxyneodecanoate, t-butyl peroxy-2-ethylhexanoate, t-butyl peroxylaurate, t-butyl peroxybenzoate, t-butylperoxyisopropyl carbonate, di-t-butyl peroxyisophthalate, t-butyl peroxyallylcarbonate, t-amyl peroxy-2-ethylhexanoate, di-t-butyl peroxyhexahydroterephthalate, and di-t-butyl peroxyazelate.

The binding resin has a glass transition point (Tg) of preferably 45° C. or more and 70° C. or less, more preferably 50° C. or more and 70° C. or less from the viewpoint of its storage stability.

In addition, the binding resin to be used in the present invention preferably has an acid value (mgKOH/g) in terms of the charging stability of the toner. The acid value is preferably 10.0 mgKOH/g or more and 60.0 mgKOH/g or less, more preferably 15.0 mgKOH/g or more and 40.0 mgKOH/g or less.

The toner of the present invention can be used as a magnetic toner by further incorporating a magnetic material. In this case, the magnetic material can also function as a colorant.

In the present invention, examples of the magnetic material in the magnetic toner include: iron oxides such as magnetite, hematite, and ferrite; and metals such as iron, cobalt, and nickel, and alloys and mixtures of these metals with metals such as aluminum, cobalt, copper, lead, magnesium, tin, zinc, antimony, bismuth, calcium, manganese, titanium, tungsten, and vanadium.

Such magnetic material has an average particle diameter of preferably 2 μm or less, more preferably 0.05 μm or more and 0.5 μm or less. The magnetic material is incorporated into the toner in an amount of preferably 20 parts by mass or more and 200 parts by mass or less with respect to 100 parts by mass of the resin component, particularly preferably 40 parts by mass or more and 150 parts by mass or less with respect to 100 parts by mass of the resin component.

As the colorant to be used in the present invention, carbon black or grafted carbon as a black colorant or a substance toned to black by using the following yellow/magenta/cyan colorants may be used.

Examples of the yellow colorant include compounds typified by: condensed azo compounds; an isoindolinone compound; an anthraquinone compound; an azo metal complex; a methine compound; and an arylamide compound.

Examples of the magenta colorant include: condensed azo compounds; a diketopyrrolopyrrole compound; anthraquinone; a quinacridone compound; a basic dye lake compound; a naphthol compound; a benzimidazolone compound; a thioindigo compound; and a perylene compound.

Examples of the cyan colorant include: a copper phthalocyanine compounds and derivatives thereof; an anthraquinone compound; and a basic dye lake compound. Those colorants may be used alone or as mixtures. Further, the colorants may be used in a solid solution state.

The colorant of the present invention is selected from the viewpoints of hue angle, chroma saturation, brightness, weatherability, OHP transparency, and dispersibility in toner. The addition amount of the colorant is 1 part by mass or more and 20 parts by mass or less with respect to 100 parts by mass of the resin.

The toner of the present invention may also contain a wax.

Examples of the wax to be used in the present invention include the following: aliphatic hydrocarbon-based waxes such as low-molecular-weight polyethylene, low-molecular-weight polypropylene, a polyolefin copolymer, a polyolefin wax, a microcrystalline wax, a paraffin wax, and a Fischer-Tropsch wax; oxides of aliphatic hydrocarbon-based waxes such as a polyethylene oxide wax; or block copolymers of the waxes; plant-based waxes such as a candelilla wax, a carnauba wax, a haze wax, and a jojoba wax; animal-based waxes such as a bees wax, lanolin, and a spermaceti wax; mineral-based waxes such as ozokerite, ceresin, and petrolatum; waxes containing fatty acid esters as main components such as a montanic acid ester wax and a castor wax; and partially or wholly deacidified fatty acid esters such as a deacidified carnauba wax. The examples further include: saturated linear fatty acids such as palmitic acid, stearic acid, montanic acid, and a long-chain alkylcarboxylic acid having an additionally long alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and an alkyl alcohol having an additionally long alkyl group; polyhydric alcohols such as sorbitol; fatty amides such as linoleic amide, oleic amide, and lauric amide; saturated fatty bis amides such as methylene bis stearamide, ethylene bis capramide, ethylene bis lauramide, and hexamethylene bis stearamide; unsaturated fatty amides such as ethylene bis oleamide, hexamethylene bis oleamide, N,N′-dioleyl adipamide, and N,N′-dioleyl sebacamide; aromatic bis amides such as m-xylene bis stearamide and N—N′-distearyl isophthalamide; aliphatic metal salts (which are generally referred to as metallic soaps) such as calcium stearate, calcium laurate, zinc stearate, and magnesium stearate; waxes obtained by grafting aliphatic hydrocarbon-based waxes with vinyl-based monomers such as styrene and acrylic acid; partially esterified products of fatty acids and polyhydric alcohols such as behenic monoglyceride; and methyl ester compounds each having a hydroxyl group obtained by the hydrogenation of vegetable oil.

In addition, the waxes whose molecular weight distribution is sharpened by a press sweating method, a solvent method, a recrystallization method, a vacuum distillation method, a supercritical gas extraction method, or a melt crystallization method, or waxes from which a low-molecular-weight solid fatty acid, a low-molecular-weight solid alcohol, a low-molecular-weight solid compound, or other impurities are removed are also preferably used.

Specific examples of the waxes that may be used as release agents include: biscol (trademark) 330-P, 550-P, 660-P, and TS-200 (Sanyo Chemical Industries, Ltd.); Hiwax 400P, 200P, 100P, 410P, 420P, 320P, 220P, 210P, and 110P (Mitsui Chemicals, Inc.); Sasol H1, H2, C80, C105, and C77 (Schumann Sasol); HNP-1, HNP-3, HNP-9, HNP-10, HNP-11, and HNP-12 (NIPPON SEIRO CO., LTD.); Unilin (trademark) 350, 425, 550, and 700 and Unisid (trademark) 350, 425, 550, and 700 (TOYO-PETROLITE); and a haze wax, a beeswax, a rice wax, a candelilla wax, and a carnauba wax (available from CERARICA NODA Co., Ltd.).

A flowability improver may be added to the toner of the present invention. The flowability improver can increase the flowability of the toner through its external addition to the toner particles when comparing before and after the addition. Examples of such flowability improver include: fluororesin powder such as vinylidene fluoride fine powder or polytetrafluoroethylene fine powder; fine powder silica such as wet process silica or dry process silica, fine powder titanium oxide, fine powder alumina, and modified silica thereof obtained by a surface treatment with a silane compound, a titanium coupling agent, and silicone oil; an oxide such as zinc oxide or tin oxide; a multiple oxide such as strontium titanate, barium titanate, calcium titanate, strontium zirconate, or calcium zirconate; and a carbonate compound such as calcium carbonate or magnesium carbonate.

A preferred flowability improver is fine powder produced through the vapor phase oxidation of a silicon halide compound, the fine powder being called dry process silica or fumed silica. For example, such silica is produced by utilizing a thermal decomposition oxidation reaction of a silicon tetrachloride gas in an oxy-hydrogen flame, and a basic reaction formula for the reaction is as follows.

SiCl₄+2H₂+O₂→SiO₂+4HCl

In the production process, composite fine powder of silica and any other metal oxide can also be obtained by using a silicon halide compound with any other metal halide compound such as aluminum chloride or titanium chloride, and the silica comprehends the composite fine powder as well. The silica fine powder to be used has an average primary particle diameter of preferably 0.001 μm or more and 2 μm or less, particularly preferably 0.002 μm or more and 0.2 μm or less.

Examples of commercially available silica fine powder produced through the vapor phase oxidation of a silicon halide compound include those commercially available under the following trade names, which can also be suitably used in the present invention: AEROSIL (NIPPON AEROSIL CO., LTD.) 130, 200, 300, 380, TT600, MOX170, MOX80, and COK84; Ca—O-SiL (CABOT Co.) M-5, MS-7, MS-75, HS-5, and EH-5; Wacker HDK N 20 (WACKER-CHEMIE GMBH) V15, N20E, T30, and T40; D-C Fine Silica (DOW CORNING Co.); and Fransol (Fransil).

Further, it is preferred to use, as the flowability improver to be used in the present invention, treated silica fine powder obtained by hydrophobizing silica fine powder generated by vapor phase oxidation of the silicon halide compound.

Hydrophobicity is imparted through chemical treatment with, for example, an organosilicon compound that reacts with or physically adsorbs to the silica fine powder. The hydrophobizing treatment is preferably performed by a method involving treating the silica fine powder produced by vapor phase oxidation of the silicon halide compound with the organosilicon compound.

Examples of the organosilicon compound include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, a triorganosilylmercaptan, trimethylsilylmercaptan, a triorganosilyl acrylate, vinyldimethylacetoxysilane, dimethylethoxysilane, dimethyldimethoxysilane, diphenyldiethoxysilane, hexamethyldisiloxane, 1,3-divinyltetramethyldisiloxane, 1,3-diphenyltetramethyldisiloxane, and a dimethylpolysiloxane having 2 or more and 12 or less siloxane units per molecule and containing a hydroxyl group bonded to one Si atom in a unit positioned at the end. Further examples include silicone oils such as a dimethyl silicone oil. One kind of those compounds is used alone, or two or more kinds thereof are used as a mixture.

A good result is obtained when the flowability improver has a specific surface area based on nitrogen adsorption measured by a BET method of 30 m²/g or more, preferably 50 m²/g or more. The flowability improver is desirably used in a total amount of 0.01 part by mass or more and 8 parts by mass or less, preferably 0.1 part by mass or more and 4 parts by mass or less with respect to 100 parts by mass of the toner.

The toner of the present invention can be used as a one-component developer by being mixed with the flowability improver and being further mixed with any other external additive (such as a charge controlling agent) as required, or can be used as a two-component developer by being used in combination with a carrier. Any conventionally known carrier can be used as the carrier for use in the two-component development method. Specifically, particles having the following characteristics are preferably used: the particles are each made of a metal with its surface oxidized or unoxidized such as iron, nickel, cobalt, manganese, chromium, or a rare earth metal, or an alloy or oxide thereof, and the particles have an average particle diameter of 20 μm or more and 300 μm or less.

In addition, a substance such as a styrene-based resin, an acrylic-based resin, a silicone-based resin, a fluorine-based resin, or a polyester resin is preferably caused to adhere to, or cover, the surface of each carrier particle.

In order to produce the toner of the present invention, a mixture containing the binding resin and the charge controlling agent is used as a material. As required, a magnetic substance, a wax, and any other additives are used. The toner can be produced by: mixing the materials sufficiently by means of a mixer such as a Henschel mixer or a ball mill; melting and kneading the mixture by means of a heat kneader such as a roll, a kneader, or an extruder so that the resins are compatible with each other; dispersing a wax or a magnetic substance therein; cooling the resultant for solidification; and pulverizing and classifying the solidified product.

The toner of the present invention can be produced with a known production apparatus, and for example, the following production apparatus can be used depending on conditions.

As the toner production apparatus, examples of the mixer include: Henschel mixer (manufactured by Mitsui Mining Co., Ltd.); Super Mixer (manufactured by KAWATA MFG Co., Ltd.); Ribocone (manufactured by OKAWARA CORPORATION); Nauta Mixer, Turburizer, and Cyclomix (manufactured by Hosokawa Micron); Spiral Pin Mixer (manufactured by Pacific Machinery & Engineering Co., Ltd.); and Loedige Mixer (manufactured by MATSUBO Corporation).

Examples of the kneader include: KRC kneader (manufactured by Kurimoto Ironworks Co., Ltd.); Buss Co-kneader (manufactured by Buss Co., Ltd.); TEM-type extruder (manufactured by TOSHIBA MACHINE Co., Ltd.); TEX Biaxial Kneader (manufactured by The Japan Steel Works, Ltd.); PCM Kneader (manufactured by Ikegai machinery Co.); Three-Roll Mill, Mixing Roll Mill, and Kneader (manufactured by Inoue Manufacturing Co., Ltd.); Kneadex (manufactured by Mitsui Mining Co., Ltd.); MS-type Pressure Kneader, and Kneader-Ruder (manufactured by Moriyama Manufacturing Co., Ltd.); and Banbury Mixer (manufactured by Kobe Steel, Ltd.).

Examples of the pulverizer include: Counter Jet Mill, Micron Jet, and Inomizer (manufactured by Hosokawa Micron); IDS-type Mill and PJM Jet Mill (manufactured by Nippon Pneumatic MFG Co., Ltd.); Cross Jet Mill (manufactured by Kurimoto Tekkosho KK); Ulmax (manufactured by Nisso Engineering Co., Ltd.); SK Jet O-Mill (manufactured by Seishin Enterprise Co., Ltd.); Criptron (manufactured by Kawasaki Heavy Industries, Ltd.); Turbo Mill (manufactured by Turbo Kogyo Co., Ltd.); and Super Rotor (manufactured by Nisshin Engineering Inc.).

Examples of the classifier include: Classiel, Micron Classifier, and Spedic Classifier (manufactured by Seishin Enterprise Co., Ltd.); Turbo Classifier (manufactured by Nisshin Engineering Inc.); Micron Separator, Turboprex (ATP), and TSP Separator (manufactured by Hosokawa Micron); Elbow Jet (manufactured by Nittetsu Mining Co., Ltd.); Dispersion Separator (manufactured by Nippon Pneumatic MFG Co., Ltd.); and YM Microcut (manufactured by Yasukawa Shoji K.K.).

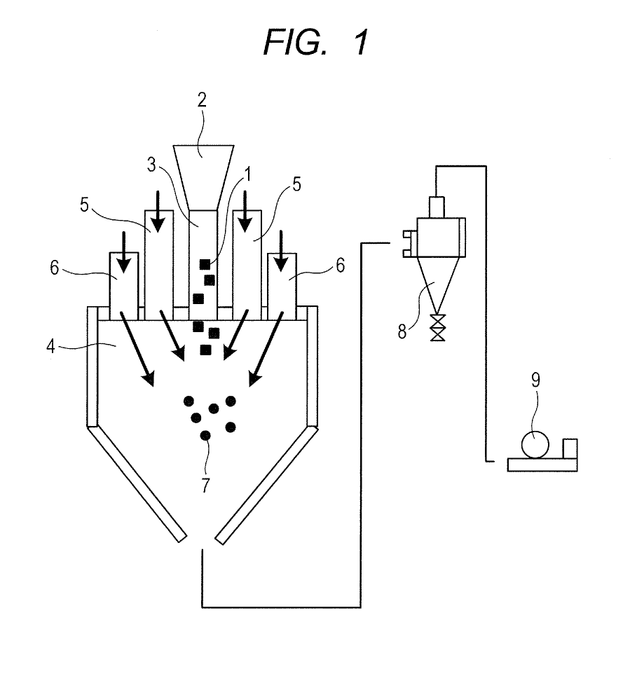

As a surface modification apparatus, there are given, for example, Faculty (manufactured by Hosokawa Micron), Mechanofusion (manufactured by Hosokawa Micron), Nobilta (manufactured by Hosokawa Micron), Hybridizer (manufactured by NARA MACHINERY CO., LTD.), Inomizer (manufactured by Hosokawa Micron), Theta Composer (manufactured by TOKUJU CORPORATION), MECHANOMILL (manufactured by OKADA SEIKO CO., LTD.), and a heat treatment apparatus as illustrated in FIG. 1.

The heat treatment apparatus illustrated in FIG. 1 is described. Toner particles 1 are supplied in a certain amount to a surface modification apparatus inside 4 with an auto-feeder 2 through a supplying nozzle 3. The toner particles 1 introduced from the supplying nozzle 3 are dispersed in the apparatus because the surface modification apparatus inside 4 is sucked with a blower 9. Heat is instantaneously applied to the toner particles 1 dispersed in the apparatus by hot air introduced from a hot air-introducing port 5 to subject the toner particles to surface modification. Although the hot air is generated with a heater in the present invention, an apparatus for the generation is not particularly limited as long as the apparatus can generate hot air sufficient for the surface modification of the toner particles. Surface-modified toner particles 7 are instantaneously cooled with cold air introduced from a cold air-introducing port 6. Although liquid nitrogen is used as the cold air in the present invention, a method for the cooling is not particularly limited as long as the method can instantaneously cool the surface-modified toner particles 7. The surface-modified toner particles 7 are sucked with the blower 9 and then collected with a cyclone 8.

Examples of the sifter for sieving coarse particles and the like include: Ultra Sonic (manufactured by Koei Sangyo Co., Ltd.); Rezona Sieve and Gyro Sifter (manufactured by Tokuju Corporation); Vibrasonic System (manufactured by Dalton Co., Ltd.); Sonicreen (manufactured by Shinto Kogyo K.K.); Turbo Screener (manufactured by Turbo Kogyo Co., Ltd.); Microsifter (manufactured by Makino mfg. co., Ltd.); and circular vibrating sieves.

The effect of the present invention can be easily obtained when the toner of the present invention has a weight-average particle diameter (D4) of 2.5 to 10.0 μm, preferably 6.0 to 8.0 μm.

Measurements of various physical properties of the toner of the present invention are described below.

### <Measurement Method for Weight-Average Particle Diameter (D4)>

The weight-average particle diameter (D4) of the toner is calculated as follows by using, as a measurement device, a precision particle size distribution measuring apparatus based on a pore electrical resistance method provided with a 100-μm aperture tube “Coulter Counter Multisizer 3” (trademark, manufactured by Beckman Coulter, Inc), and dedicated software included thereto “Beckman Coulter Multisizer 3 Version 3.51” (manufactured by Beckman Coulter, Inc) is used for setting measurement conditions and analyzing measurement data. It should be noted that the measurement is performed while the number of effective measurement channels is set to 25,000.

An electrolyte aqueous solution prepared by dissolving special grade sodium chloride in ion-exchanged water to have a concentration of about 1 mass %, for example, an “ISOTON II” (manufactured by Beckman Coulter, Inc) can be used in the measurement.

It should be noted that the dedicated software was set as described below prior to the measurement and the analysis.

In the “change standard measurement method (SOM)” screen of the dedicated software, the total count number of a control mode is set to 50,000 particles, the number of times of measurement is set to 1, and a value obtained by using “standard particles each having a particle diameter of 10.0 μm” (manufactured by Beckman Coulter, Inc) is set as a Kd value. A threshold and a noise level are automatically set by pressing a “threshold/noise level measurement” button. In addition, a current is set to 1,600 μA, a gain is set to 2, and an electrolyte solution is set to an ISOTON II, and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256, and a particle diameter range is set to the range of 2 μm to 60 μm.

A specific measurement method is as described below.

(1) About 200 ml of the electrolyte aqueous solution are charged into a 250-ml round-bottom beaker made of glass dedicated for the Multisizer 3. The beaker is set in a sample stand, and the electrolyte aqueous solution in the beaker is stirred with a stirrer rod at 24 rotations/sec in a counterclockwise direction. Then, dirt and bubbles in the aperture tube are removed by the “aperture flush” function of the dedicated software.

(2) About 30 ml of the electrolyte aqueous solution are charged into a 100-ml flat-bottom beaker made of glass. About 0.3 ml of a diluted solution prepared by diluting a “Contaminon N” (a 10-mass % aqueous solution of a neutral detergent for washing a precision measuring device formed of a nonionic surfactant, an anionic surfactant, and an organic builder and having a pH of 7, manufactured by Wako Pure Chemical Industries, Ltd.) with ion-exchanged water by three mass fold is added as a dispersant to the electrolyte aqueous solution.

(3) An ultrasonic dispersing unit “Ultrasonic Dispension System Tetora 150” (manufactured by Nikkaki Bios Co., Ltd.) in which two oscillators each having an oscillatory frequency of 50 kHz are built so as to be out of phase by 180° and which has an electrical output of 120 W is prepared. About 3.3 l of ion-exchanged water are charged into the water tank of the ultrasonic dispersing unit. About 2 ml of the Contaminon N are charged into the water tank.

(4) The beaker in the section (2) is set in the beaker fixing hole of the ultrasonic dispersing unit, and the ultrasonic dispersing unit is operated. Then, the height position of the beaker is adjusted in order that the liquid level of the electrolyte aqueous solution in the beaker may resonate to the fullest extent possible.

(5) About 10 mg of toner are gradually added to and dispersed in the electrolyte aqueous solution in the beaker in the section (4) in a state where the electrolyte aqueous solution is irradiated with an ultrasonic wave. Then, the ultrasonic dispersion treatment is continued for an additional 60 seconds. It should be noted that the temperature of water in the water tank is appropriately adjusted so as to be 10° C. or higher and 40° C. or lower upon ultrasonic dispersion.

(6) The electrolyte aqueous solution in the section (5) in which the toner has been dispersed is dropped with a pipette to the round-bottom beaker in the section (1) placed in the sample stand, and the concentration of the toner to be measured is adjusted to about 5%. Then, measurement is performed until the particle diameters of 50,000 particles are measured.

(7) The measurement data is analyzed with the dedicated software included with the apparatus, and the weight-average particle diameter (D4) is calculated. It should be noted that an “average diameter” on the “analysis/volume statistics (arithmetic average)” screen of the dedicated software when the dedicated software is set to show a graph in a vol % unit is the weight-average particle diameter (D4).

### <Measurement Method for Average Circularity>

The average circularity of toner was measured under measurement and analysis conditions at the time of correction operation with a flow-type particle image analyzer “FPIA-3000” (manufactured by SYSMEX CORPORATION).

A specific measurement method is as described below. First, about 20 ml of ion-exchanged water from which an impure solid and the like have been removed in advance are charged into a container made of glass. About 0.2 ml of a diluted solution prepared by diluting a “Contaminon N” (a 10-mass % aqueous solution of a neutral detergent for washing a precision measuring unit formed of a nonionic surfactant, an anionic surfactant, and an organic builder and having a pH of 7, manufactured by Wako Pure Chemical Industries, Ltd.) with ion-exchanged water by about three mass fold is added as a dispersant to the container. Further, about 0.02 g of a measurement sample is added to the container, and then the mixture is subjected to a dispersion treatment with an ultrasonic dispersing unit for 2 minutes so that a dispersion liquid for measurement may be obtained. At that time, the dispersion liquid is appropriately cooled so as to have a temperature of 10° C. to 40° C. A desktop ultrasonic cleaning and dispersing unit having an oscillatory frequency of 50 kHz and an electrical output of 150 W (such as a “VS-150” (manufactured by VELVO-CLEAR)) is used as the ultrasonic dispersing unit. A predetermined amount of ion-exchanged water is charged into a water tank, and about 2 ml of the Contaminon N are added to the water tank.

The flow-type particle image analyzer mounted with an “LUCPLFLN” (magnification: 20, numerical aperture: 0.40) as an objective lens was used in the measurement, and a particle sheath “PSE-900A” (manufactured by SYSMEX CORPORATION) was used as a sheath liquid. The dispersion liquid prepared in accordance with the procedure is introduced into the flow-type particle image analyzer, and 2,000 toner particles are subjected to measurement according to the total count mode of an HPF measurement mode. Then, the average circularity of the toner was determined with a binarization threshold at the time of particle analysis set to 85% and particle diameters to be analyzed limited to ones each corresponding to a circle-equivalent diameter of 1.977 μm or more and less than 39.54 μm.

On the measurement, automatic focusing is performed with standard latex particles (obtained by diluting, for example, “RESEARCH AND TEST PARTICLES Latex Microsphere Suspensions 5100A” manufactured by Duke Scientific with ion-exchanged water) prior to the initiation of the measurement. After that, focusing is preferably performed every two hours from the initiation of the measurement.

It should be noted that in Examples of the present application, a flow-type particle image analyzer which had been subjected to a calibration operation by SYSMEX CORPORATION and received a calibration certificate issued by SYSMEX CORPORATION was used. The measurement was performed under measurement and analysis conditions identical to those at the time of the reception of the calibration certificate except that particle diameters to be analyzed were limited to ones each corresponding to a circle-equivalent diameter of 1.977 μm or more and less than 39.54 μm.

### <Measurement Method for X-Ray Diffraction>

A measuring apparatus “RINT-TTRII” (manufactured by Rigaku Corporation), and control software and analysis software included with the apparatus are used in the X-ray diffraction measurement of a charge controlling agent.

Measurement conditions are as described below.

X-ray: Cu/50 kV/300 mA

Goniometer: rotor horizontal goniometer (TTR-2)

Attachment: standard sample holder

Filter: Not used

Incident monochrometer: Not used

Counter monochrometer: Not used

Divergence slit: open

Divergence vertical limiting slit: 10.00 mm

Scattering slit: open

Receiving slit: open

Counter: scintillation counter

Scan mode: continuous

Scan speed: 4.0000°/min.

Sampling width: 0.0200°

Scanning axis: 2θ/θ

Scanning range: 10.0000 to 40.0000°

θ offset: 0.0000°

Subsequently, the charge controlling agent is set on a nonreflective sample plate made of silicon and then the measurement is initiated. Analysis is performed by subjecting the resultant measured profile to the following processings in order. The analysis was performed with reference to an instruction manual “part 4: basic data processing” manufactured by Rigaku Corporation.

### (1) Smoothing

Smoothing is performed for removing the disturbance of the profile due to the noises of X-rays. When a small noise is detected as a diffraction peak, there is a possibility that enormous amounts of diffraction peaks appear, and accurate peak positions of the peaks having the first and second highest intensities that are important in the present invention cannot be calculated. A general processing method is as follows: a weighted average method is employed as a smoothing processing method and an automatic processing is used as a parameter determination method.

### (2) Background Removal

The intensity of a diffraction peak is determined by calculating a height from the position of a background to the position of the peak. Accordingly, background removal is performed for accurately calculating the intensity of the diffraction peak. Sonnevelt-Visser's method is employed for the background removal. Sonnevelt-Visser's method is a method involving setting an intensity threshold and a peak width threshold to estimate a value for the background automatically. The intensity threshold is set to 10 and the peak width threshold is set to 0.5.

(3) Kα2 removal

An incident X-ray Kα is formed of two components Kα1 and Kα2 whose intensity ratio is 2:1. The Kα2 component is removed from the resultant diffraction ray for the following purpose: to know the true profile by leaving only one of the components. The intensity ratio is set to 0.5.

### (4) Peak Search

A diffraction peak is detected. A manual mode is selected for a peak search, the intensity threshold is set to 60, and the peak width threshold is set to 0.5.

### <Method of Measuring N₂ Molecule Adsorption-Desorption Isotherm>

The N₂ molecule adsorption-desorption isotherm of the charge controlling agent at a temperature of 77 K is measured with a pore distribution-measuring apparatus Tristar 3000 (manufactured by Shimadzu Corporation) by a gas adsorption method involving causing a nitrogen gas to adsorb to the surface of a sample. The outline of the measurement is described in an operation manual issued from Shimadzu Corporation and is as described below. Before the measurement, 0.3 to 0.5 g of a sample was loaded into a sample tube and then vacuum drawing was performed at 23° C. for 24 hours. After the completion of the vacuum drawing, the mass of the sample was precisely weighed, whereby the sample was obtained. The N₂ molecule adsorption-desorption isotherm of the resultant sample at a temperature of 77 K was obtained by using the pore distribution-measuring apparatus. A difference (M2−M1) between an adsorption amount M1 (cm³/g) of an adsorption process when a relative pressure p/p₀ (p₀: saturated vapor pressure) was 0.4 and an adsorption amount M2 (cm³/g) of a desorption process when the relative pressure p/p₀ was 0.4 was calculated from the resultant adsorption-desorption isotherm.

### EXAMPLES

Hereinafter, the present invention is specifically described by way of Examples. It should be noted that the term “part(s)” in Examples refers to “part(s) by mass” unless otherwise stated.

### <Production Example of Binding Resin (A-1)>

Polyester monomers were mixed at the following ratio.

| | |
|---|---|
| Terephthalic acid: | 1.200 mol |
| Fumaric acid: | 3.500 mol |
| Ethylene glycol: | 4.450 mol |
| Neopentyl glycol: | 0.600 mol |

The monomers were loaded into a reaction vessel provided with a cooling tube, a stirring machine, and a nitrogen-introducing tube, 0.1 mass % of tetrabutyl titanate was added as a polymerization catalyst to the mixture, and the mixture was subjected to a reaction at 220° C. in a stream of nitrogen for 10 hours while produced water was removed by distillation. Next, the mixture was subjected to a reaction under a reduced pressure of 5 to 20 mmHg, and when its acid value became 2 mgKOH/g or less, the resultant was cooled to 180° C. and then 0.500 mol of trimellitic anhydride was added to the resultant. The mixture was subjected to a reaction at normal pressure in a sealed state for 2 hours and then the resultant was taken out. The resultant was cooled to room temperature and then pulverized to provide a binding resin (A-1) (Tg=61.5° C., acid value=25.0 mgKOH/g).

### <Production Example of Binding Resin (A-2)>

Polyester monomers were mixed at the following ratio. Bisphenol derivative represented by the formula (2) (R: propylene group, average of x+y: 2.2): 1.250 mol

Terephthalic acid: 0.430 mol

Isophthalic acid: 0.400 mol

Dodecenylsuccinic anhydride: 0.170 mol

The monomers were loaded into a reaction vessel provided with a cooling tube, a stirring machine, and a nitrogen-introducing tube, 0.1 mass % of tetrabutyl titanate was added as a polymerization catalyst to the mixture, and the mixture was subjected to a reaction at 220° C. in a stream of nitrogen for 10 hours while produced water was removed by distillation. Next, the mixture was subjected to a reaction under a reduced pressure of 5 to 20 mmHg, and when its acid value became 2 mgKOH/g or less, the resultant was cooled to 180° C. and then 0.300 mol of trimellitic anhydride was added to the resultant. The mixture was subjected to a reaction at normal pressure in a sealed state for 2 hours and then the resultant was taken out. The resultant was cooled to room temperature and then pulverized to provide a binding resin (A-2) (Tg=59.0° C., acid value=20.0 mgKOH/g).

### <Production Example of Binding Resin (A-3)>

70 Parts of styrene, 24 parts of n-butyl acrylate, 6 parts of monobutyl maleate, and 1 part of di-t-butyl peroxide were dropped to 200 parts of xylene over 4 hours. Further, polymerization was completed under xylene reflux. After that, the temperature of the resultant was increased, the organic solvent was removed by distillation, and the residue was cooled to room temperature and then pulverized to provide a binding resin (A-3) (Tg=60.0° C., acid value=8.5 mgKOH/g).

### <Charge Controlling Agents (C-1) to (C-6)>

Charge controlling agents having the following features were used as charge controlling agents (C-1) to (C-6).

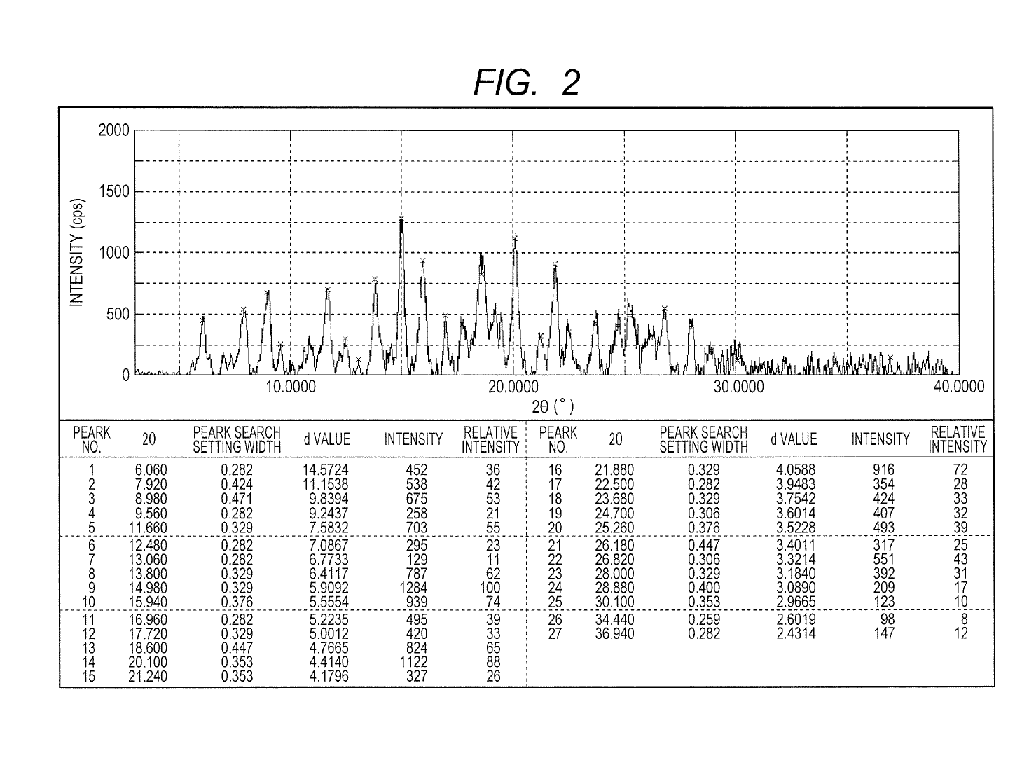

The structures of the charge controlling agents (C-1) to (C-6) were identified by an infrared absorption spectrum, a visible absorption spectrum, elemental analysis (C, H, N), atomic absorption analysis, and a mass spectrum. As a result, it was confirmed that each of the charge controlling agents was a compound represented by the formula (1). In addition, FIGS. 2 to 7 show the X-ray diffraction spectra of the respective charge controlling agents, and Table 1 shows the positions of a peak having the maximum intensity and peaks having second to fourth highest intensities, and an adsorption amount M1 and adsorption amount difference M2−M1 in N₂ molecule adsorption-desorption isotherm at a temperature of 77 K.

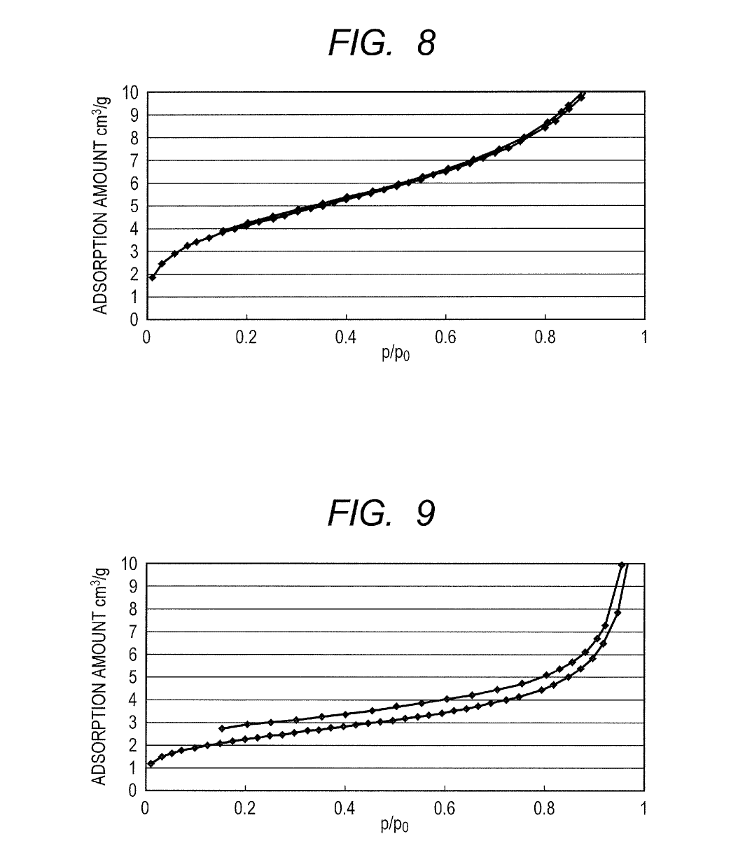

In addition, FIG. 8 and FIG. 9 show the profiles of the N₂ molecule adsorption-desorption isotherms of the charge controlling agents (C-1) and (C-5) at 77 K, respectively as representative examples of the adsorption-desorption isotherm.

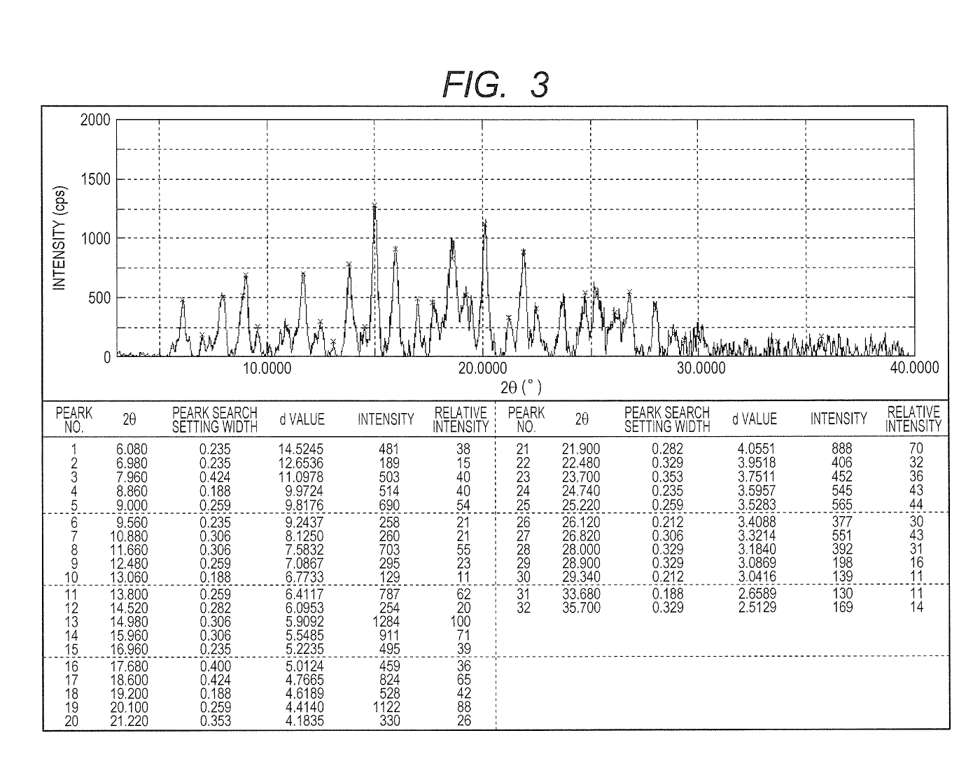

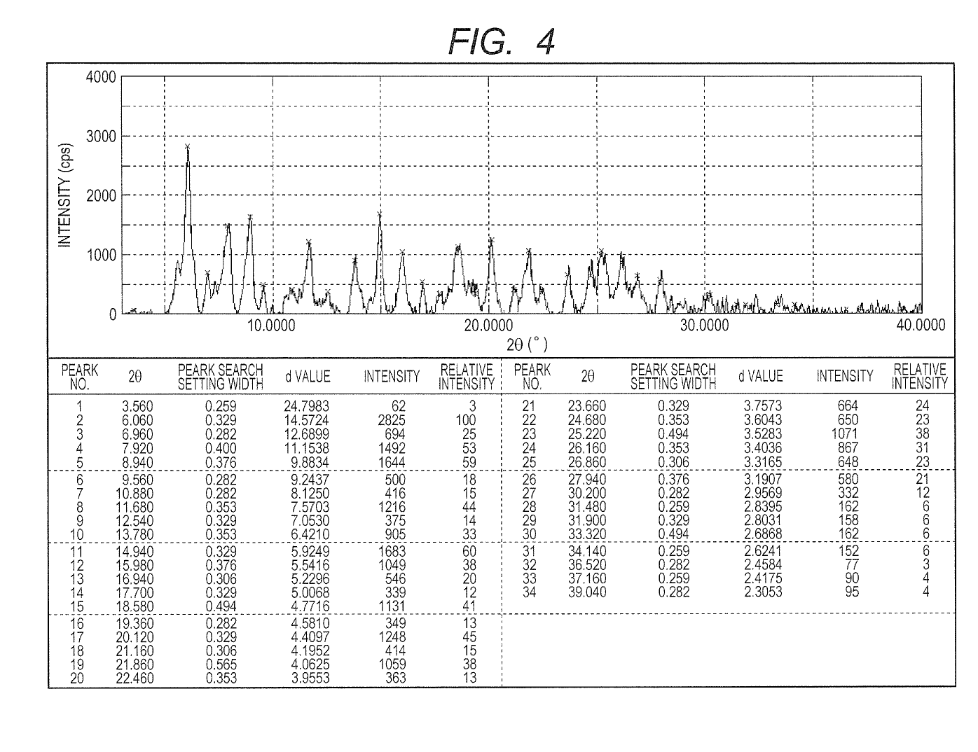

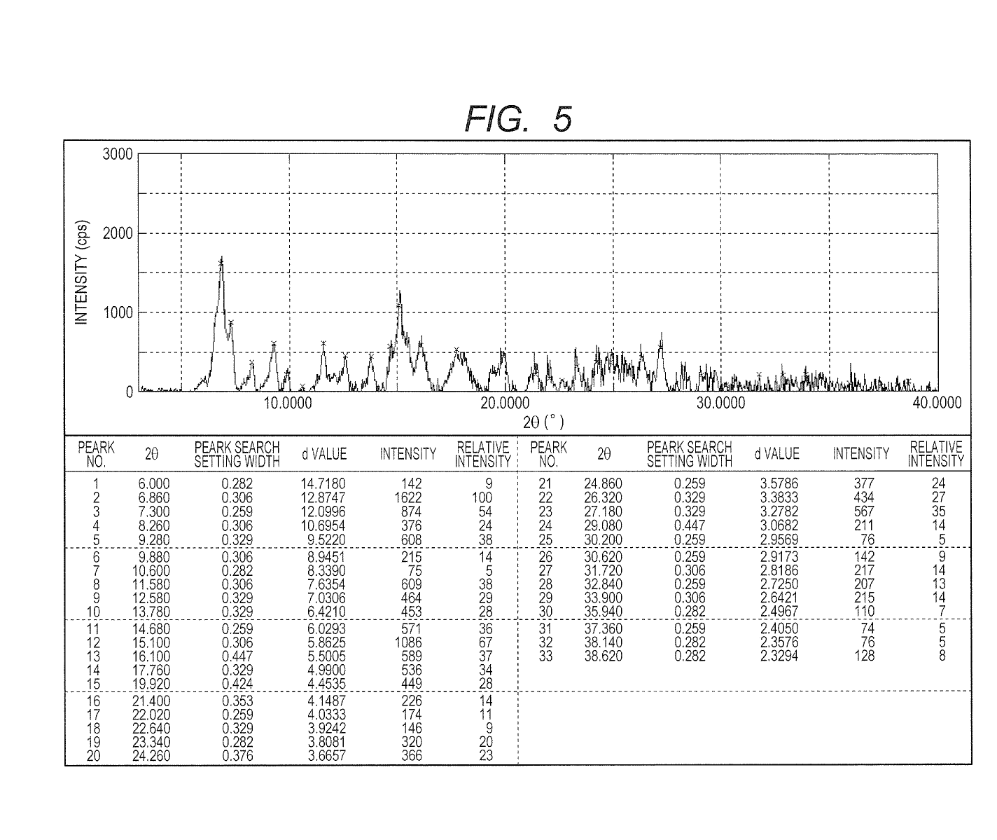

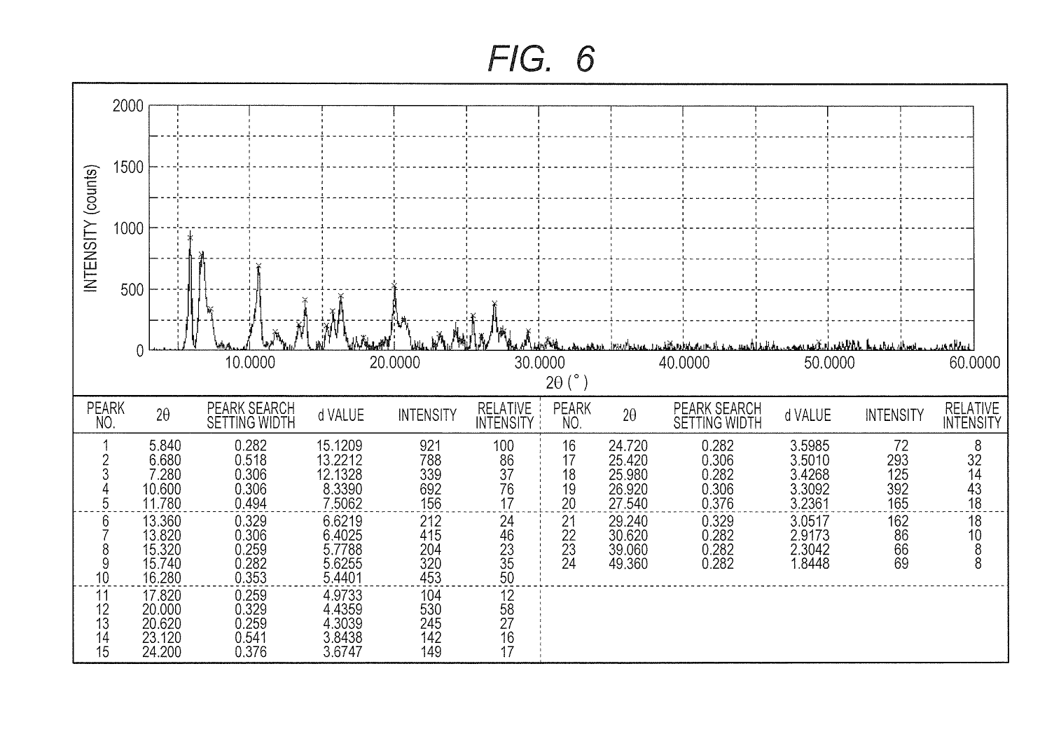

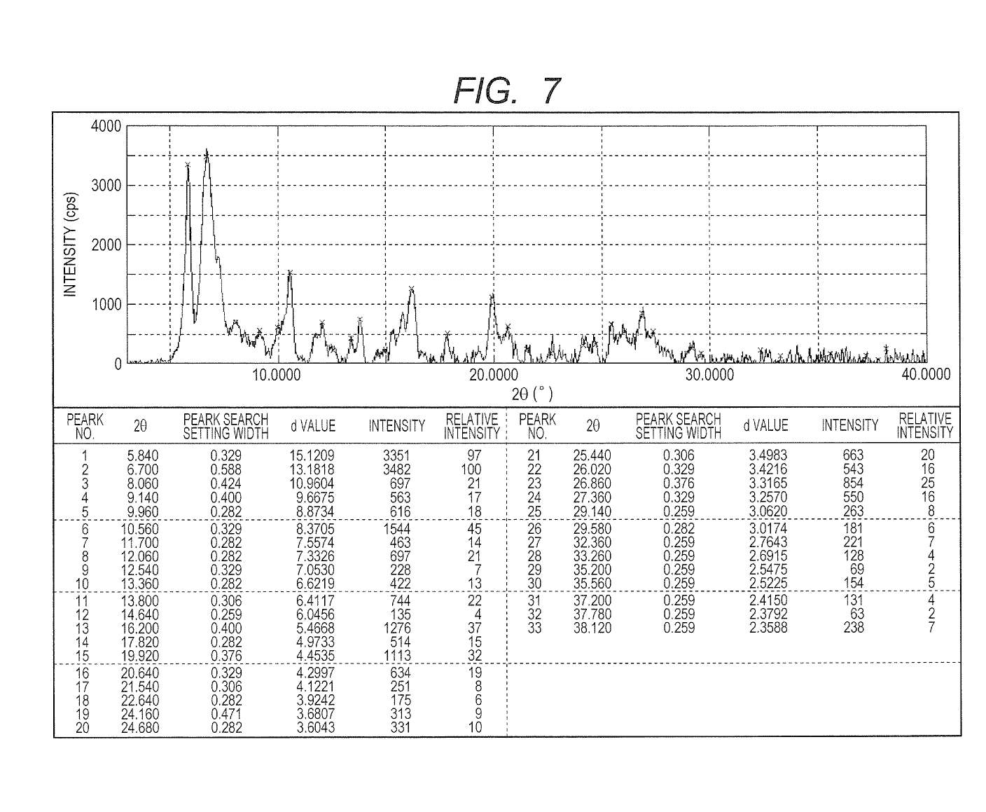

TABLE 1

| | | | 2Θ(°) | | | | | |
|---|---|---|---|---|---|---|---|---|
| | | | | Peak having | Peak having | Peak having | | Adsorption |
| Charge | | X-ray | Peak having | second | third | fourth | Adsorption | amount difference |
| controlling | | diffraction | maximum | maximum | maximum | maximum | amount M1 | M2 − M1 |
| agent | Structure | spectrum | intensity | intensity | intensity | intensity | (cm³/g) | (cm³/g) |
| C-1 | Formula (1) | FIG. 2 | 14.980 | 20.100 | 15.940 | 21.880 | 5.3 | 0.12 |
| C-2 | Formula (1) | FIG. 3 | 14.980 | 20.100 | 15.960 | 21.900 | 4.3 | 0.11 |
| C-3 | Formula (1) | FIG. 4 | 14.940 | 20.120 | 11.680 | 18.580 | 5.9 | 0.18 |
| C-4 | Formula (1) | FIG. 5 | 15.100 | 11.580 | 16.100 | 14.680 | 7.1 | 0.91 |
| C-5 | Formula (1) | FIG. 6 | 10.600 | 20.000 | 16.280 | 13.820 | 2.9 | 0.54 |
| C-6 | Formula (1) | FIG. 7 | 10.560 | 16.200 | 19.920 | 26.860 | 6.6 | 0.43 |

### Example 1

Binding resin (A-1): 100 parts
Magnetic iron oxide particles: 90 parts

(Average particle diameter: 0.20 μm, Hc=11.5 kA/m, σs=85 Am²/kg, σr=16 Am²/kg)
Fischer-Tropsch wax (manufactured by Sasol Wax, C105, melting point: 105° C.): 2 parts
Charge controlling agent (C-1): 1 part

The materials were premixed with a Henschel mixer. After that, the mixture was melted and kneaded with a PCM-30 (manufactured by Ikegai Corporation) while the temperature of the apparatus was set so that the temperature of a molten product at an ejection port became 150° C. The resultant kneaded product was cooled and coarsely pulverized with a hammer mill. After that, the coarsely pulverized product was finely pulverized with a Turbomill T250 (manufactured by FREUND-TURBO CORPORATION) as a pulverizer. A fine pulverization temperature at this time was 48° C. The term “fine pulverization temperature” refers to a temperature measured at a portion where toner is discharged from the inside of the pulverizer. The resultant finely pulverized powder was classified with a multi-division classifier utilizing a Coanda effect.

The resultant classified product was subjected to a heat treatment with the surface modification apparatus illustrated in FIG. 1 to provide toner particles 1 having a weight-average particle diameter (D4) of 7.2 μm and an average circularity of 0.978. Conditions for the surface modification were as follows: a raw material supply rate of 2 kg/hr, a hot air flow rate of 700 L/min, a hot air ejection temperature of 300° C., a cold air ejection temperature of −15° C., and an injection pressure to be supplied from the supplying nozzle of 0.2 MPa.

Next, 1.0 part of hydrophobic silica fine powder (obtained by subjecting 100 parts of silica fine powder having a BET specific surface area of 150 m²/g to a hydrophobic treatment with 30 parts of hexamethyldisilazane (HMDS) and 10 parts of dimethyl silicone oil) and 3.0 parts of strontium titanate fine powder (D50: 1.0 μm) were externally added and mixed into 100 parts of the toner particles, and then the mixture was sieved with a mesh having an aperture of 150 μm to provide a toner 1.

Part of the resultant toner 1 was left to stand under a heat cycle environment. Conditions for a heat cycle are described below.

<1> A temperature is held at 25° C. for 1 hour.

<2> The temperature is linearly increased to 45° C. over 11 hours.

<3> The temperature is held at 45° C. for 1 hour.

<4> The temperature is linearly decreased to 25° C. over 11 hours.

A procedure from the items <1> to <4> was defined as 1 cycle and a total of 20 cycles were performed.

The following evaluations were performed on the toner before and after the standing. Table 3 shows the results of the evaluations before the performance of the standing under the heat cycle environment and Table 4 shows the results of the evaluations after the standing under the heat cycle environment. A commercially available digital copying machine image RUNNER 2545i (manufactured by Canon Inc.) with a magnetic one-component system was used as an evaluation machine.

### <Evaluation for Developability>

The toner was loaded into a predetermined process cartridge. An image output test was performed on a total of 1,000 sheets according to a mode set as follows and then an image density on the 1,000-th sheet was measured: to print a horizontal line pattern having a print percentage of 2% on 2 sheets was defined as 1 job, and the machine stopped once between a job and the next job before the next job started. The evaluation was performed under normal temperature and normal humidity (25.0° C. and 60% RH), and under low temperature and low humidity (10° C. and 30% RH) where the charging performance of the toner easily appeared in a significant manner. The image density was measured by measuring the reflection density of a circular solid black image having a diameter of 5 mm with a Macbeth densitometer (manufactured by Macbeth) as a reflection densitometer together with an SPI filter. A larger numerical value means that developability is better.

### <Evaluation for Fogging Value>

In the evaluation for developability, the worst value for the reflection density of the white portion of an image after the 1,000-sheet endurance was represented by Ds, the average reflection density of a transfer material before the image formation was represented by Dr, and Dr-Ds was defined as a fogging value. A reflection densitometer (REFLECTOMETER MODEL TC-6DS manufactured by Tokyo Denshoku CO., LTD.) was used in the measurement of the reflection density of the white portion. A smaller numerical value means that the suppression of fogging is better.

### <Evaluation for Electrostatic Offset>

The toner was loaded into a predetermined process cartridge, and was then subjected to moisture conditioning under a low-temperature and low-humidity environment (10° C. and 30% RH) for 3 hours. Image output was continuously performed on 100 sheets of A4 paper having a basis weight of 75 g/m² by using such a chart for an electrostatic offset test that the former half of an image was solid black and the latter half thereof was white. The white portion of the resultant image was visually observed and then whether an offset image was observed in the white portion was confirmed. Evaluation criteria are described below.

A: An offset image is not observed in any one of the sheets from the first sheet to the 100-th sheet.

B: An offset image is slightly observed in multiple sheets including the first sheet but is not observed in any one of the 10-th and subsequent sheets.

C: An offset image is slightly observed in multiple sheets including the first sheet but is not observed in any one of the 50-th and subsequent sheets.

D: An offset image is slightly observed in the first sheet and does not disappear even in the 100-th sheet.

E: A clear offset image is observed even in the first sheet.

With regard to Example 1, good results were obtained for the respective evaluations. Table 2 shows a binding resin and charge controlling agent used in each of Examples 2 to 8 and Comparative Examples 1 to 3, the fine pulverization temperature at the time of the production of a toner, the presence or absence of surface modification and the kind of the surface modification, and the weight-average particle diameter (D4) and average circularity of the toner.

### Example 2

A toner 2 was obtained in the same manner as in Example 1 except that a mechanical surface treatment was performed with a Faculty F-600 (manufactured by Hosokawa Micron Corporation) instead of the performance of the heat treatment with the surface modification apparatus illustrated in FIG. 1. The treatment was performed at a number of revolutions of the dispersion rotor of the Faculty F-600 of 100 s⁻¹ (a rotational peripheral speed of 140 m/sec) for 15 seconds. The resultant toner was subjected to the same evaluations as those of Example 1. Table 3 and Table 4 show the results.

### Example 3

A toner 3 was obtained in the same manner as in Example 1 except that the surface modification with the surface modification apparatus illustrated in FIG. 1 was not performed. The resultant toner was subjected to the same evaluations as those of Example 1. Table 3 and Table 4 show the results.

### Example 4

A toner 4 was obtained in the same manner as in Example 3 except that the charge controlling agent (C-2) was used. The resultant toner was subjected to the same evaluations as those of Example 1. Table 3 and Table 4 show the results.

### Example 5

A toner 5 was obtained in the same manner as in Example 3 except that the charge controlling agent (C-3) was used. The resultant toner was subjected to the same evaluations as those of Example 1. Table 3 and Table 4 show the results.

### Example 6

A toner 6 was obtained in the same manner as in Example 5 except that the fine pulverization temperature was changed to 40° C. The resultant toner was subjected to the same evaluations as those of Example 1. Table 3 and Table 4 show the results.

### Example 7

A toner 7 was obtained in the same manner as in Example 6 except that the binding resin (A-2) was used. The resultant toner was subjected to the same evaluations as those of Example 1. Table 3 and Table 4 show the results.

### Example 8

A toner 8 was obtained in the same manner as in Example 6 except that the binding resin (A-3) was used. The resultant toner was subjected to the same evaluations as those of Example 1. Table 3 and Table 4 show the results.

### Comparative Examples 1 to 3

Comparative toners 1 to 3 were obtained in the same manner as in Example 6 except that the charge controlling agent to be used was changed as shown in Table 2. The resultant toners were subjected to the same evaluations as those of Example 1. Table 3 and Table 4 show the results.

TABLE 2

| | | Charge | Fine | | Weight-average | |
|---|---|---|---|---|---|---|
| | Binding | controlling | pulverization | Surface | particle diameter | Average |
| | resin | agent | temperature | treatment | (D4) | circularity |
| Toner 1 | A-1 | C-1 | 48° C. | Heat | 7.2 | 0.978 |
| | | | | treatment | | |
| Toner 2 | A-1 | C-1 | 48° C. | Mechanical | 7.1 | 0.951 |
| | | | | treatment | | |
| Toner 3 | A-1 | C-1 | 48° C. | None | 7.2 | 0.942 |
| Toner 4 | A-1 | C-2 | 48° C. | None | 7.1 | 0.943 |
| Toner 5 | A-1 | C-3 | 48° C. | None | 7.3 | 0.942 |
| Toner 6 | A-1 | C-3 | 40° C. | None | 7.3 | 0.935 |
| Toner 7 | A-2 | C-3 | 40° C. | None | 7.2 | 0.935 |
| Toner 8 | A-3 | C-3 | 40° C. | None | 7.3 | 0.935 |
| Comparative | A-1 | C-4 | 40° C. | None | 7.2 | 0.936 |
| toner 1 | | | | | | |
| Comparative | A-1 | C-5 | 40° C. | None | 7.1 | 0.934 |
| toner 2 | | | | | | |
| Comparative | A-1 | C-6 | 40° C. | None | 7.3 | 0.935 |
| toner 3 | | | | | | |

TABLE 3
Evaluation before standing under heat cycle environment

| | | Normal-temperature and normal-humidity | | Low-temperature and low-humidity | | |
|---|---|---|---|---|---|---|
| | | environment (25.0° C., 60% RH) | | environment (10.0° C., 30% RH) | | |
| | | 1,000-th sheet | | 1,000-th sheet | | Electrostatic |
| | | Image density | Fogging | Image density | Fogging | offset |
| Example 1 | Toner 1 | 1.52 | 0.2 | 1.50 | 0.3 | A |
| Example 2 | Toner 2 | 1.50 | 0.3 | 1.48 | 0.4 | A |
| Example 3 | Toner 3 | 1.49 | 0.5 | 1.47 | 0.7 | A |
| Example 4 | Toner 4 | 1.48 | 0.6 | 1.46 | 0.8 | A |
| Example 5 | Toner 5 | 1.44 | 0.6 | 1.43 | 1.0 | A |
| Example 6 | Toner 6 | 1.43 | 0.7 | 1.42 | 1.3 | A |
| Example 7 | Toner 7 | 1.40 | 0.7 | 1.39 | 1.7 | A |
| Example 8 | Toner 8 | 1.38 | 0.8 | 1.37 | 1.8 | A |
| Comparative | Comparative | 1.37 | 0.8 | 1.35 | 1.9 | B |
| example 1 | toner 1 | | | | | |
| Comparative | Comparative | 1.36 | 0.8 | 1.35 | 2.1 | B |
| example 2 | toner 2 | | | | | |
| Comparative | Comparative | 1.35 | 0.9 | 1.32 | 2.2 | B |
| example 3 | toner 3 | | | | | |

TABLE 4
Evaluation after standing under heat cycle environment

| | | Normal-temperature and normal-humidity | | Low-temperature and low-humidity | | |
|---|---|---|---|---|---|---|
| | | environment (25.0° C., 60% RH) | | environment (10.0° C., 30% RH) | | |
| | | 1,000-th sheet | | 1,000-th sheet | | Electrostatic |
| | | Image density | Fogging | Image density | Fogging | offset |
| Example 1 | Toner 1 | 1.51 | 0.4 | 1.49 | 0.6 | A |
| Example 2 | Toner 2 | 1.48 | 0.5 | 1.47 | 0.7 | A |
| Example 3 | Toner 3 | 1.48 | 0.7 | 1.45 | 1.1 | B |
| Example 4 | Toner 4 | 1.48 | 0.7 | 1.44 | 1.1 | B |
| Example 5 | Toner 5 | 1.42 | 0.8 | 1.35 | 1.2 | C |
| Example 6 | Toner 6 | 1.42 | 1.0 | 1.34 | 1.9 | C |
| Example 7 | Toner 7 | 1.38 | 1.1 | 1.27 | 2.1 | D |
| Example 8 | Toner 8 | 1.37 | 1.1 | 1.21 | 2.1 | D |
| Comparative | Comparative | 1.34 | 1.3 | 1.11 | 3.8 | E |
| example 1 | toner 1 | | | | | |
| Comparative | Comparative | 1.33 | 1.4 | 1.08 | 3.9 | E |
| example 2 | toner 2 | | | | | |
| Comparative | Comparative | 1.31 | 1.6 | 1.03 | 3.9 | E |
| example 3 | toner 3 | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-206873, filed Sep. 20, 2012, which is hereby incorporated by reference herein in its entirety.

### REFERENCE SIGNS LIST

1 toner particle
2 auto-feeder
3 supplying nozzle
4 surface modification apparatus inside
5 hot air-introducing port
6 cold air-introducing port
7 surface-modified toner particle
8 cyclone
9 blower

1. A toner comprising toner particles each containing a binding resin and a charge controlling agent,
wherein
the charge controlling agent
(i) comprises a compound represented by the following formula (1), and
(ii) has peaks at 15.000°±0.150° and 20.100°±0.150° in CuKα X-ray diffraction spectrum obtained in 20 range of 10° or more to 40° or less where 0 represents Bragg angle, one of the peaks being a peak having a maximum intensity in the 2θ range and the other being a peak having a second maximum intensity in the 2θ range.

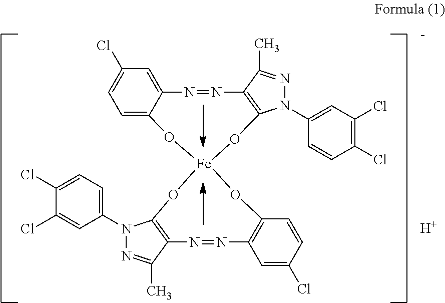

2. The toner according to claim 1, wherein in N₂ molecule adsorption-desorption isotherm of the charge controlling agent at a temperature of 77 K, an adsorption amount M1 of an adsorption process when a relative pressure is 0.4 is 3.0 cm³/g or more and 8.0 cm³/g or less, and a difference (M2−M1) between the M1 and an adsorption amount M2 (cm³/g) of a desorption process when the relative pressure is 0.4 is 0.4 cm³/g or less.

3. The toner according to claim 1, wherein the toner has an average circularity of 0.940 or more.
